(19) United States
(12) Patent Application Publication
(10) Pub. No.: US 2023/0272135 A1
(43) Pub. Date: Aug. 31, 2023

(54) FLUOROPOLYMER COMPOSITION

(71) Applicant: SOLVAY SPECIALTY POLYMERS ITALY S.P.A., Bollate (Milano) (IT)

(72) Inventors: Stefana Musio, Saronno (IT); Serena Carella, Parabiago (IT); Giulio Brinati, Milan (IT)

(73) Assignee: SOLVAY SPECIALTY POLYMERS ITALY S.P.A., Bollate (Milano) (IT)

(21) Appl. No.: 18/043,712

(22) PCT Filed: Aug. 23, 2021
(86) PCT No.: PCT/EP2021/073297

§ 371 Date: Mar. 1, 2023

(30) Foreign Application Priority Data
Sep. 1, 2020 (EP) 20193970.9

(51) Int. Cl. C08F 214/24

(52) U.S. Cl. CPC C08F 214/245

(57) ABSTRACT

The invention pertains to a thermoplastic fluoropolymer composition comprising one or more polymer A comprising recurring units derived from ethylene and recurring units derived from halogenated monomers selected from chlorotrifluoroethylene (CTFE) and tetrafluoroethylene (TFE) and one or more polymer B comprising recurring units derived from ethylene, recurring units derived from halogenated monomers selected from CTFE and TFE, and recurring units derived from hexafluoroisobutylene (HFIB) and/or perfluoropropylvinylether (PPVE). The resulting composition allows to manufacture films having exceptional transparency and good mechanical properties which can be used for examples as architectural films.

### TECHNICAL FIELD

This application claims priority to the European Patent Application filed on 1 Sep. 2020 with number 20193970.9, the whole content of this application being incorporated herein by reference for all purposes.

The invention pertains to a fluoropolymer composition comprising one or more semi crystalline polymer A comprising ethylene recurring units (E) and halogenated recurring units selected from chlorotrifluoroethylene (CTFE), tetrafluoroethylene (TFE) or mixtures thereof, and a one or more fluorinated polymer B comprising ethylene recurring units (E), halogenated recurring units selected from chlorotrifluoroethylene (CTFE), tetrafluoroethylene (TFE) or mixtures thereof and additional recurring units derived from hexafluoroisobutylene (HFIB) and/or perfluoropropylvinylether (PPVE). The composition of the invention allows to produce films having an improved balance of mechanical properties and transparency if compared with prior art solutions.

### BACKGROUND ART

Copolymers of ethylene with chlorotrifluoroethylene (ECTFE), tetrafluoroethylene (ETFE) or mixtures thereof are well known in the art, in particular for the manufacture of films and protective layers.

These materials provide films having excellent, weatherability, stain resistance and a relatively good level of transparency, which are often considered as valuable properties for a protective film; this is particularly true when these protective films are intended to be used as architectural films, agricultural films, as protective sheeting for photovoltaic cells, as packaging materials and the like.

In order to improve the optical properties of these materials, semi crystalline ECTFE has been found to provide films with excellent transparency, however films made from these materials were found to have a slightly reduced mechanical resistance if compared with ETFE films which are widely used in the architectural covers industry but, on the other hand, offer a relatively poor performance in terms of transparency. WO2012049242A1 from Solvay Specialty Polymers Italy describes compositions comprising a semi crystalline ECTFE or ETFE polymer and dispersed particles of a UV blocker compound from which transparent films can be obtained.

There is therefore a need to provide thermoplastic fluoropolymer compositions which can form films having excellent transparency and, at the same time, excellent mechanical properties, if compared with the prior art solutions.

### SUMMARY OF INVENTION

The present invention relates to a thermoplastic fluoropolymer composition comprising:
51-99 % by weight, based on the total weight of the composition, of one or more polymer A which comprises recurring units derived from ethylene and recurring units derived from halogenated monomers selected from chlorotrifluoroethylene (CTFE) and tetrafluoroethylene (TFE), wherein the molar ratio between the ethylene recurring units and the halogenated recurring units is from 40:60 to 49:51, and
1-49 % by weight based on the total weight of the composition of one or more polymer B which comprises recurring units derived from ethylene, recurring units derived from halogenated monomers selected from chlorotrifluoroethylene (CTFE) and tetrafluoroethylene (TFE), and 1-20% in moles, based on the total moles of recurring units in the polymer, of recurring units derived from hexafluoroisobutylene (HFIB) and/or perfluoropropylvinylether (PPVE), and wherein the molar ratio between said ethylene recurring units and said halogenated recurring units is from 40:60 to 60:40.

The present invention also relates to a process for manufacturing the composition described above, to the use of the composition for manufacturing films, to films obtained from the composition, to multilayer structures comprising the films, and to the use of these films or multilayer structures as architectural membranes, facades, protective films for photovoltaic modules, as films for transportation, for industrial and food packaging or for pharmaceutical storage and packaging.

### DETAILED DESCRIPTION OF THE INVENTION

The present invention relates to a thermoplastic fluoropolymer composition combining excellent transparency with good mechanical properties. The composition of the invention finds application in particular in the manufacture of films which can be employed in architecture, for example for transparent coverings for roofs or facades. The composition of the invention can also be used successfully in any application wherein compositions based on ETFE or ECTFE polymers are currently used, for example in photovoltaic modules (as protective films), films for transportation, in food, agriculture and drugs packaging, in design and construction of furniture, pods, toys and in general in any application wherein a thermoplastic material having a high transparency and a good mechanical resistance combined with weatherability and stain resistance are needed.

It is well known in the art that 50/50 mol/mol ECTFE or ETFE copolymers show a maximum of crystallinity, i.e. of both melting point and heat of fusion.

As mentioned in the introduction, ETFE and ECTFE polymers having an excess of the halogenated recurring units (typically having a molar ratio between ethylene recurring units and halogenated recurring units from 40:60 to 49:51) have a lower crystallinity degree and are known to provide films with excellent transparency. At the same time these materials have a slightly reduced mechanical resistance which makes them less suitable than 50/50 mol/mol ECTFE or ETFE copolymers for those applications wherein mechanical resistance is of key importance such as for example in films for architectural coverings.

Transparency is however a highly desirable benefit for the same applications, particularly in architecture, as well as in food packaging and others, therefore there is a continued need to provide films from ECTFE/ETFE polymers which, while maintaining the mechanical resistance of 50/50 mol/mol ECTFE or ETFE copolymers, also have an improved transparency.

The composition of the invention addresses this technical problem by combining a larger amount of one or more highly transparent polymer which is a semi crystalline ECTFE or ETFE polymer having an excess of halogenated monomers, with a smaller amount of a second reinforcing polymer which comprises recurring units derived by ethylene, one or more from chlorotrifluoroethylene and tetrafluoroethylene, and one or more from hexafluoroisobutylene (HFIB) and/or perfluoropropylvinylether (PPVE).

A composition comprising polymers belonging to both of these classes has been found to provide films being essentially just as transparent as the highly transparent polymer, but having greatly improved mechanical resistance. This effect is unexpected because, in general, a mixture of different polymers, especially when considering almost completely transparent and hazeless materials, generates an increase in haze and a reduction in visible light transmittance, due to the imperfect mixing of the components.

More specifically, the present invention relates to a thermoplastic fluoropolymer composition comprising 51-99 %, preferably 51-90%, more preferably 51-80%, even more preferably 55-70% by weight (based on the total weight of the composition) of one or more polymer A and 1-49 %, preferably 10-49%, more preferably 20-49%, most preferably 30-45% by weight (based on the total weight of the composition) of one or more polymer B.

Polymer A is defined as a polymer comprising recurring units derived from ethylene and recurring units derived from halogenated monomers selected from chlorotrifluoroethylene (CTFE) and tetrafluoroethylene (TFE), wherein the molar ratio between ethylene recurring units and halogenated recurring units is from 40:60 to 49:51, preferably from 42:58 to 46:54. in other words wherein the halogenated recurring units are present in a molar excess as defined by the above ratio ranges.

Preferably, the polymer A is a semi crystalline polymer. A semi crystalline polymer, for the purposes of the present invention, is defined as a polymer having a relatively low heat of fusion. Preferably the polymer A has a heat of fusion of at most 35 J/g, preferably of at most 30 J/g, more preferably of at most 25 J/g.

Without lower limit for heat of fusion being critical, it is nevertheless understood that polymer A will generally possess a heat of fusion of at least 1 J/g, preferably of at least 2 J/g, more preferably of at least 5 J/g.

The heat of fusion of polymer A is determined by Differential Scanning Calorimetry (DSC) at a heating rate of 10° C./min, according to ASTM D 3418.

As mentioned above, 50/50 mol/mol ECTFE or ETFE copolymers show a maximum of crystallinity, the requirement for a heat of fusion of at most 35 J/g can thus be achieved either by increasing or by decreasing the amount of ethylene with respect to this 50/50 molar ratio.

It is nevertheless understood that polymers A for the purpose of the invention are indeed those comprising an excess of halogenated recurring units as mentioned above.

Preferably for polymer A, the sum of the recurring units derived from ethylene and the recurring units derived from halogenated monomers selected from CTFE and TFE, represents more than 90%, preferably more than 95%, more preferably more than 97.5%, even more preferably more than 99% and most preferably 100% in moles of the total of the recurring units making up the polymer A.

In the non-preferred embodiment wherein case an additional comonomer is present in polymer A beyond ethylene, CTFE and TFE, preferably such additional comonomer is a hydrogenated comonomer selected from the group of the (meth)acrylic monomers. More preferably the hydrogenated comonomer is selected from the group of the hydroxyalkylacrylate comonomers, such as hydroxyethylacrylate, hydroxypropylacrylate and (hydroxy)ethylhexylacrylate, and alkyl acrylate comomnomers, such as n-butyl acrylate.

Among polymers A, ECTFE copolymers, i.e. copolymers of ethylene and CTFE and optionally an additional comonomer, as above detailed, are preferred.

ECTFE polymers suitable as polymer(s) A in the composition of the invention typically possess a melting temperature not exceeding 225° C., preferably not exceeding 215° C., more preferably not exceeding 210° C., even more preferably not exceeding 207° C. At the same time the ECTFE polymers suitable as polymer(s) A in the composition of the invention typically possess a melting temperature of at least 160° C., preferably of at least 180° C., more preferably of at least 190° C., even more preferably of at least 200° C.

The melting temperature is determined by Differential Scanning Calorimetry (DSC) at a heating rate of 10° C./min, according to ASTM D 3418.

Polymers which have been found to give particularly good results as polymer A are those consisting essentially of recurring units derived from:
(a) from 40 to 49%, preferably from 42 to 46% by moles of ethylene (E);
(b) from 51 to 60%, preferably from 54 to 58% by moles of chlorotrifluoroethylene (CTFE).

End chains, defects or minor amounts of monomer impurities leading to recurring units different from those above mentioned can be still comprised in the polymers A, without this affecting properties of the material.

The melt flow rate of the polymers A, measured following the procedure of ASTM 3275-81 at 275° C. and 2.16 Kg, ranges generally from 0.01 to 75 g/10 min, preferably from 0.1 to 50 g/10 min, more preferably from 0.5 to 30 g/10 min.

Polymer B is defined as a polymer comprising recurring units derived from ethylene, recurring units derived from halogenated monomers selected from chlorotrifluoroethylene (CTFE) and tetrafluoroethylene (TFE), and 1-20%, preferably 2-15%, more preferably 2-10%, even more preferably 3-7% in moles (based on the total moles of recurring units in the polymer) of additional recurring units derived from hexafluoroisobutylene (HFIB) and/or perfluoropropylvinylether (PPVE). In the most preferred embodiments said additional recurring units are all derived from HFIB. The molar ratio between said ethylene recurring units and said halogenated recurring units is from 40:60 to 60:40, preferably from 45:55 to 55:45, most preferably from 49:51 to 51:49.

Preferably, for polymer B, the sum of the recurring units derived from ethylene, CTFE, TFE, HFIB and PPVE represents more than 90%, preferably more than 95%, more preferably more than 97.5%, even more preferably more than 99% and most preferably 100% in moles of the total of the recurring units making up the polymer B.

In the non-preferred case wherein an additional comonomer is present in polymer B beyond ethylene, CTFE,TFE, HFIB and PPVE, preferably such additional comonomer is a hydrogenated comonomer selected from the group of the (meth)acrylic monomers. More preferably the hydrogenated comonomer is selected from the group of the hydroxyalkylacrylate comonomers, such as hydroxyethylacrylate, hydroxypropylacrylate and (hydroxy)ethylhexylacrylate, and alkyl acrylate comomnomers, such as n-butyl acrylate.

End chains, defects or minor amounts of monomer impurities leading to recurring units different from those above mentioned can be still comprised in the polymers B, without this affecting properties of the material.

While the compositions of the invention are preferably consisting essentially of polymer(s) A and polymer(s) B only, they may contain also additional conventional ingredients and additives such as pigments, dyes, UV filters, stabilizers, plasticizers, preservatives, antioxidants etc. In general it is preferred that all these additional ingredients, different from polymer(s) A or B, in combination, do not exceed 20%, preferably 10%, more preferably 5%, even more preferably 1% by weight based on the total weight of the composition.

The composition according to the invention is particularly suitable for manufacturing architectural membranes, but can also be used in all applications of ECTFE and ETFE films such as protective films, including films for protecting photovoltaic modules, in particular for front-sheets or back-sheets of PV cells, agricultural films, packaging films etc.

Another aspect of the present invention relates to a process for manufacturing the thermoplastic fluoropolymer composition as above described, said process comprising mixing the polymers A and B, as above detailed. Such mixing can be obtained with any technique known in the art used for blending thermoplastic polymers for dry blending and/or melt compounding. For example powders or pellets of polymer(s) A and B can be premixed and then melt compounded into an extruder which is heated at a temperature of about 30° C. above the melting temperature of the highest melting component. Alternatively, the polymers can be molten separately and then melt compounded in a mixer or extruder. Finally once the composition is formed in molten state the composition can be extruded and pelletized for further processing.

Examples of suitable devices to melt compound the thermoplastic fluoropolymer composition of the invention in a continuous fashion are screw extruders. In this case, polymers A and B and optionally other ingredients, may be fed in an extruder and the thermoplastic fluoropolymer composition of the invention is extruded.

This operating method can be applied either with a view to manufacturing finished product such as, for instance, films, hollow bodies, pipes, laminates, calendared articles, or with a view to having available granules containing the desired composition in suitable proportions in the form of pellets, which facilitates a subsequent conversion into finished articles. With this latter aim, the thermoplastic fluoropolymer composition of the invention can be advantageously extruded into strands and the strands can be chopped into pellets.

Preferably, the composition of the invention is melt compounded in single-screw or twin-screw extruder. Examples of suitable extruders well-adapted to the process of the invention are those available from Leistritz, Maris America Corp. Werner and Pfleiderer and from Farrel.

Still another object of the invention is the use of the thermoplastic fluoropolymer composition of the invention for manufacturing films.

Techniques for manufacturing films are well known in the art. The composition of the invention can be preferably processed under the form of a film by cast extrusion or hot blown extrusion techniques, optionally with mono- or bi-axial orientation.

A technique particularly adapted to the manufacture of films of the composition of the invention involve extruding the molten composition through a die having elongated shape so as to obtain an extruded tape and casting/calendering said extruded tape so as to obtain a film.

A tape can be calendered into a film by passing through appropriate rolls, which can be maintained at appropriate temperatures, and whose speed can be adjusted so as to achieve the required thickness.

Films obtained from the composition of the invention are preferably transparent films, i.e. films having a total transmittance of more than 80 %, preferably more than 90 %, even more preferably more than 95 % when determined on films having a thickness of about 250 µm, when measured in water in accordance with ASTM E1003 using a ByK Haze Guard plus equipment.

Films obtained from the composition of the invention are preferably such that in transmission, the scattering of light responsible for the reduction of contrast of images viewed through it is limited. In other words, films obtained from the composition of the invention have values of Haze of less than 10, preferably of less than 5 %, even more preferably of less than 3 %, when determined on films having a thickness of about 250 µm, when measured in water in accordance with ASTM E1003 using a ByK Haze Guard plus equipment.

Films so obtained are another object of the present invention.

The films of the invention can be advantageously assembled in a multilayer structure. Multilayer structures comprising the film of the invention are still objects of the present invention.

Still within the frame of the present invention is thus the use of the film obtained from the composition of the invention as above detailed, and/or of the multilayer assembly comprising the same, as above specified, as architectural membranes, including facades, pods, balloon coverings and the like, protective films for photovoltaic modules, as films for transportation, for industrial and food packaging, for pharmaceutical storage and packaging and in general wherever ETFE or ECTFE based films are used and wherein a high transparency is desired.

Should the disclosure of any patents, patent applications, and publications which are incorporated herein by reference conflict with the description of the present application to the extent that it may render a term unclear, the present description shall take precedence.

The invention will be now described in more detail with reference to the following examples, whose purpose is merely illustrative.

### Raw Materials

### Polymers

ECTFE-A is a 44/56 mole% ethylene/chlorotrifluoroethylene (E/CTFE) copolymer commercially available under trade name HALAR^{®} 700HC having a melting point of 204° C. and a heat of fusion of 25 J/g and a MFI of 9 g/10 min (275° C./2.16 kg).

ECTFE-B: is a 47/47/6 mole% E/CTFE/HFIB terpolymer having a melting point of 224° C., and a MFI of 11 g/10 min (275° C./2.16 kg) from Solvay.

ETFE is an ETFE polymer from 3M™ marketed as Dyneon™ Fluoroplastic ET 6235Z which is a typical ETFE grade used in architectural coverings.

### General Manufacturing Procedure of the Compositions of the Invention

The polymers were provided under the form of powder. In the case of the compositions according to the invention the components polymer ECTFE-A and ECTFE-B, were pre-mixed. The powders (the blended powders in the case of the samples formed by more than one component) were melted at temperature 30° C. higher than the melting point of the highest melting component and extruded in a single screw extruder thereby obtaining pellets of the same composition.

For manufacturing thin films, pellets were processed in an extruder equipped with conventional film forming head. In order to obtain a film thickness of about 250 µm.

### Films Characterization

Films 250 µm thick obtained as above detailed were submitted to optical testing.

Total Trasmittance (TT) and Haze were measured in water in accordance with ASTM E1003 using a ByK Haze Guard plus equipment. Yellow Index (YI), was measured in accordance with ASTM E313 using a ByK Color-view colorimeter (using D65 daylight illuminant and observer at 10°).

### Mechanical Properties

Yield Stress measurements were performed on films 250 µm thick at 25° C., 46° C. e 57° C., in Machine Direction (MD) e Transversal Direction (TD) on 5 film samples according to ASTM D3307. For the measurement an Instron 5965 instrument has been used with a 1kN cell and flat clamps. Traction speed was 50 mm/min. Grip distance 22 mm.

TABLE 1

Mechanical and optical properties

| | Yeld Stress MD | | | Yeld Stress TD | | | Water | | YI |
|---|---|---|---|---|---|---|---|---|---|
| | 25° C. | 46° C. | 57° C. | 25° C. | 46° C. | 57° C. | TT% | Haze% | |
| ECTFE A (comp) | 27.1 | 18.9 | 15.9 | 27.2 | 18.5 | 15.4 | 96.9 | 2.1 | 0.8 |
| ECTFE B (comp) | 34 | 26 | 22 | 34 | 25 | 21 | 94.6 | 11.8 | 1.1 |
| 60%wt ECTFE A + 40% wt ECTFE B | 30.9 | 22.1 | 17.4 | 30.9 | 21.9 | 17.8 | 98.6 | 1.6 | 2.0 |
| ETFE (comp) | 26.1 | 19.8 | 17.9 | 27.3 | 21.0 | 18.6 | 94 | 5.0 | 2.0 |

The data presented in the table show that a film made with the composition of the invention has improved mechanical properties with respect to ECTFE-A and comparable mechanical properties to an ETFE film which is the industry standard for good mechanical properties in architectural films. Moreover films according to the invention have an improved total transmittance and reduced haze compared with the ETFE film, and essentially identical total transmittance and haze as a film made of ECTFE-A alone which is the industry standard for a high transmittance film. Films made from ECTFE B only have very good mechanical properties but also poor transparency and haze. Overall a composition according to the invention provides films having an improved balance between mechanical properties and optical properties (transmittance and haze) with respect to known materials.

1. A thermoplastic fluoropolymer composition comprising:
51-99 % by weight based on the total weight of the composition of one or more polymer A, said polymer A comprising recurring units derived from ethylene and recurring units derived from halogenated monomers selected from the group consisting of chlorotrifluoroethylene (CTFE) and tetrafluoroethylene (TFE), wherein the molar ratio between said ethylene recurring units and said halogenated recurring units is from 40:60 to 49:51, and
1-49 % by weight based on the total weight of the composition of one or more polymer B, said polymer B comprising recurring units derived from ethylene, recurring units derived from halogenated monomers selected from the group consisting of chlorotrifluoroethylene (CTFE) and tetrafluoroethylene (TFE), and 1-20% in moles, based on the total moles of recurring units in the polymer, of recurring units derived from hexafluoroisobutylene (HFIB) and/or perfluoropropylvinylether (PPVE), and wherein the molar ratio between said ethylene recurring units and said halogenated recurring units is from 40:60 to 60:40.

2. The thermoplastic fluoropolymer composition according to claim 1 wherein said polymer A has a heat of fusion of at most 35 J/g .

3. The thermoplastic fluoropolymer composition according to claim 1 wherein in said polymer A the molar ratio between ethylene recurring units and halogenated recurring units is from 42:58 to 46:54.

4. The thermoplastic fluoropolymer composition according to claim 1 comprising 51-90% by weight of said polymer A and 10-49% by weight, of said polymer B.

5. The thermoplastic fluoropolymer composition according to claim 1 wherein said polymer B comprises recurring units derived from HFIB and/or PPVE in an amount of 2-15% by moles .

6. The thermoplastic fluoropolymer composition according to claim 1 wherein said polymer B comprises recurring units derived from HFIB in an amount of 2-15% by moles.

7. The thermoplastic fluoropolymer composition according claim 1 wherein
in said polymer A, the total of the recurring units derived from ethylene and the recurring units derived from an halogenated monomer selected from CTFE and TFE, represent more than 90% in moles, of the total of recurring units making up the polymer A and
in said polymer B, the total of the recurring units derived from ethylene, the recurring units derived from an halogenated monomer selected from CTFE and TFE, and the recurring units derived from HFIB and/or PPVE represent more than 90% in moles_{;} of the total of recurring units making up the polymer B.

8. The thermoplastic fluoropolymer composition according to claim 1, wherein the polymer A is an ECTFE polymer.

9. The thermoplastic fluoropolymer composition of claim 8, wherein polymer A essentially consists of :
(a) from 40 to 49 % by moles, of recurring units derived from ethylene;
(b) from 51 to 60 % by moles, of recurring units derived from chlorotrifluoroethylene (CTFE).

10. The thermoplastic fluoropolymer composition according to claim 8, wherein the polymer A possesses a melting temperature not exceeding 225° C., and of at least 160° C.

11. A process for manufacturing the thermoplastic fluoropolymer composition of claim 1, said process comprising mixing said polymer A and said polymer B.

12. A process for manufacturing films, said process comprising: melting the thermoplastic fluoropolymer composition of claim 1, and processing the thermoplastic fluoropolymer composition .

13. A film comprising the thermoplastic fluoropolymer composition of claim 1.

14. A multilayer structure comprising the film of claim 13.

15. An article comprising the film of claim 13, wherein the article is an architectural membrane, a facade, a protective film for photovoltaic modules, a film for transportation, industrial packaging, food packaging, pharmaceutical storage, or pharmaceutical packaging .

16. The thermoplastic fluoropolymer composition according to claim 1 wherein said polymer A has a heat of fusion of at most 30 J/g.

17. The thermoplastic fluoropolymer composition according to claim 1 comprising 51-80% by weight of said polymer A and 20-49% by weight of said polymer B.

18. The thermoplastic fluoropolymer composition according to claim 1 wherein said polymer B comprises recurring units derived from HFIB and/or PPVE in an amount of 2-10% by moles.

19. The thermoplastic fluoropolymer composition according to claim 1 wherein
in said polymer A, the total of the recurring units derived from ethylene and the recurring units derived from an halogenated monomer selected from CTFE and TFE, represent more than 95% in moles of the total of recurring units making up the polymer A and
in said polymer B, the total of the recurring units derived from ethylene, the recurring units derived from an halogenated monomer selected from CTFE and TFE, and the recurring units derived from HFIB and/or PPVE represent more than 95% in moles of the total of recurring units making up the polymer B.

20. The thermoplastic fluoropolymer composition of claim 8, wherein polymer A essentially consists of:
(a) from 42 to 46 % by moles of recurring units derived from ethylene;
(b) from 54 to 58 % by moles of recurring units derived from chlorotrifluoroethylene (CTFE).
